(19) United States
(12) Patent Application Publication
(10) Pub. No.: US 2015/0272218 A1
(43) Pub. Date: Oct. 1, 2015

(54) ELECTRONIC CIGARETTE

(71) Applicant: Shenzhen Smoore Technology Limited, Shenzhen (CN)

(72) Inventor: Zhiping Chen, Shenzhen (CN)

(21) Appl. No.: 14/371,834

(22) PCT Filed: Mar. 27, 2014
(86) PCT No.: PCT/CN2014/074186

§ 371 Date: Jul. 11, 2014

(51) Int. Cl. A24F 47/00; H05B 3/22

(52) U.S. Cl. CPC A24F 47/008; H05B 3/22

(57) ABSTRACT

An electronic cigarette includes: a housing; a mouthpiece located at an end of the housing, the mouthpiece defining an air outlet thereof; an atomizing assembly received in the housing, the atomizing assembly includes: a liquid reservoir for storing liquid, the liquid reservoir defining a channel therethrough communicated with the air outlet; a liquid absorption element connected to the liquid reservoir, the liquid absorption element is configured to absorb the liquid; and a heating element connected to the liquid absorption element, the heating element is configured to atomize the liquid absorbed by the liquid absorption element into atomized gas, the atomized gas enters the channel; and a power source received in the housing and connected to the atomizing assembly, the power source being configured to provide power for the heating element. The liquid absorption element has a greater contact area with the heating element, which results in a better atomizing effect.

### PRIORITY CLAIM

The present application claims priority to PCT Patent Application PCT/CN2014/074186 filed on Mar. 27, 2014, the content of which is incorporated hereby in its entirety.

### TECHNICAL FIELD

The present application relates generally to electronic cigarettes, and more specifically to wicks used in electronic cigarettes.

### BACKGROUND

Electronic cigarettes, also known as virtual cigarettes, electronic atomizers, are a substitute of regular cigarettes for smoking cessation. Electronic cigarettes have a similar appearance and taste as regular cigarettes, but do not contain harmful ingredients as regular cigarettes do, such as tar, suspended particles, and so on.

Electronic cigarettes are usually composed of an atomizer and a power source. A conventional heating element of the atomizer is a spring-like resistance wire wrapped around a wick. When activated, the resistance wire quickly heats up thus turning the liquid absorbed by the wick into a vapor, which is then inhaled by the user. The atomizer plays an important role in the perceived quality of the vapor.

However, the wick used in existing electronic cigarettes has a relatively small volume and a relatively small surface area, which leads to inadequate absorption of liquid and poor atomization effects.

### SUMMARY

In view of the above-described problems, it is necessary to provide better atomization effects in an electronic cigarette.

An electronic cigarette includes: a housing; a mouthpiece located at an end of the housing, the mouthpiece defining an air outlet thereof; an atomizing assembly received in the housing, the atomizing assembly includes: a liquid reservoir for storing liquid, the liquid reservoir defining a channel therethrough communicated with the air outlet; a liquid absorption element connected to the liquid reservoir, the liquid absorption element being configured to absorb the liquid; and a heating element connected to the liquid absorption element, the heating element being configured to atomize the liquid absorbed by the liquid absorption element into atomized gas, the atomized gas entering the channel; and a power source received in the housing and connected to the atomizing assembly, the power source being configured to provide power for the heating element.

In one embodiment, the liquid absorption element is made of porous ceramic.

In one embodiment, the liquid absorption element is received in the channel, the liquid absorption element defines an atomizing passage therethrough communicated with the channel, the heating element is received in the atomizing passage.

In one embodiment, heating element is a spiral tubular heating wire, both ends of the heating wire are connected to the power source via wires.

In one embodiment, the liquid reservoir is filled with a storage medium.

In one embodiment, the liquid absorption element is located at an end of the liquid reservoir, the liquid absorption element defines an atomizing passage therethrough communicated with the channel, the heating element is received in the atomizing passage.

In one embodiment, the electronic cigarette further includes a reservoir cover positioned between the liquid reservoir and the liquid absorption element, wherein the reservoir cover defines a liquid conduction channel and an airflow channel, the liquid enters the liquid absorption element via the liquid conduction channel, the airflow channel is communicated with the channel, the liquid absorption element defines an atomizing passage therethrough communicated with the channel, the heating element is received in the atomizing passage.

In one embodiment, the liquid absorption element is located at an end of the liquid reservoir, the liquid absorption element defines an atomizing passage therethrough communicated with the channel, the heating element is located at an end of the liquid absorption element away from the liquid reservoir.

In one embodiment, the heating element is a planar spiral heating wire, both ends of the heating wire are connected to the power source via wires.

In one embodiment, the liquid absorption element is located at an end of the liquid reservoir, the liquid absorption element defines an atomizing passage therethrough communicated with the channel, the heating element is a heating coating coated on an inner sidewall of the atomizing passage.

Another electronic cigarette includes: a housing; a mouthpiece located at an end of the housing, the mouthpiece defining an air outlet thereof; an atomizing assembly received in the housing, the atomizing assembly includes: a liquid absorption element configured to absorb liquid, the liquid absorption element defining an atomizing passage therethrough communicated with the air outlet; and a heating element connected to the liquid absorption element, the heating element being configured to atomize the liquid absorbed by the liquid absorption element into atomized gas, the atomized gas entering the channel; and a power source received in the housing and connected to the atomizing assembly, the power source being configured to provide power for the heating element.

In one embodiment, the liquid absorption element is made of porous ceramic.

In one embodiment, the heating element is spiral tubular heating wire, both ends of the heating wire are connected to the power source via wires.

In one embodiment, the heating element is a heating coating coated on an inner sidewall of the atomizing passage.

In one embodiment, the heating element is a planar spiral heating wire located at an end of the liquid absorption element away from the mouthpiece.

Compared with the prior art, the liquid absorption element of the electronic cigarette has a greater area, it has a greater contact area with the heating element, which results in a better atomizing effect.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a exploded perspective view of a first embodiment of an electronic cigarette;

FIG. 2 is a cross-sectional view of the electronic cigarette of FIG. 1;

FIG. 3 is a exploded perspective view of a second embodiment of an electronic cigarette;

FIG. 4 is a cross-sectional view of the electronic cigarette of FIG. 3;

FIG. 5 is a exploded perspective view of a third embodiment of an electronic cigarette;

FIG. 6 is a cross-sectional view of the electronic cigarette of FIG. 5;

FIG. 7 is a exploded perspective view of a fourth embodiment of an electronic cigarette;

FIG. 8 is a cross-sectional view of the electronic cigarette of FIG. 7;

FIG. 9 is a exploded perspective view of a fifth embodiment of an electronic cigarette;

FIG. 10 is a cross-sectional view of the electronic cigarette of FIG. 9;

FIG. 11 is a exploded perspective view of a sixth embodiment of an electronic cigarette;

FIG. 12 is a cross-sectional view of the electronic cigarette of FIG. 11;

FIG. 13 is a exploded perspective view of a seventh embodiment of an electronic cigarette; and

FIG. 14 is a cross-sectional view of the electronic cigarette of FIG. 13.

### DETAILED DESCRIPTION OF THE EMBODIMENTS

Reference will now be made to the drawings to describe, in detail, embodiments of the present electronic cigarette. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,”“above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

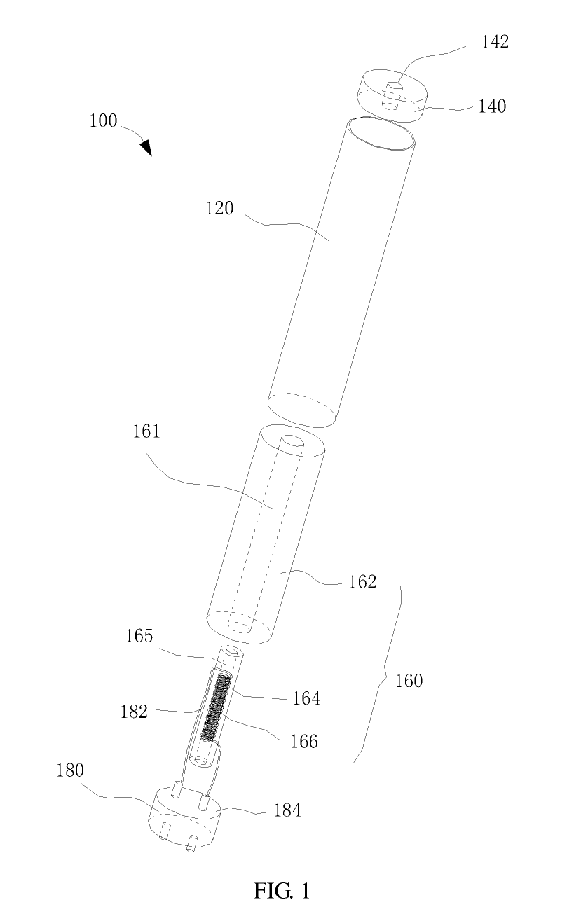

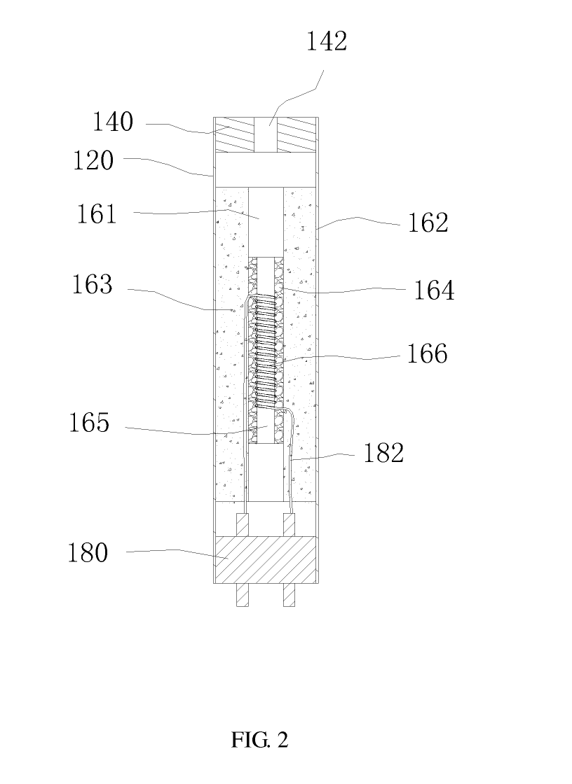

Referring to FIG. 1 and FIG. 2, a first embodiment of an electronic cigarette 100 includes a housing 120, a mouthpiece 140, an atomizing assembly 160, and a power source 180.

The housing 120 is substantially a hollow elongated cylinder. The mouthpiece 140 is located at an end of the housing 120, and the atomizing assembly 160 and the power source 180 are received inside the housing 120. It is to be understood that, the housing 120 may have other shapes, such as rectangular or the like.

The mouthpiece 140 has thread on its outer periphery, and the mouthpiece 140 is threadedly fixed at the top of the housing 120. The mouthpiece 140 defines an air outlet 142 at a center thereof.

The atomizing assembly 160 includes a liquid reservoir 162, a liquid absorption element 164, and a heating element 166.

The liquid reservoir 162 is substantially a hollow tube and is used for storing liquid. The liquid reservoir 162 internally defines a substantially cylindrical channel 161 along an axis thereof. The channel 161 is aligned with the air outlet 142. The liquid reservoir 162 is filled with a storage medium 163 for storing liquid. The storage medium 163 can be made of fibers, preferably modified fibers, which can remove the odor of the liquid, so as not to affect the taste of the smoke.

The liquid absorption element 164 is connected to the liquid reservoir 162. In the illustrated embodiment, the liquid absorption element 164 is shaped as a tube mating with the channel 161. Accordingly, the liquid absorption element 164 can be inserted into the channel 161 of the liquid reservoir 162 and be in contact with the storage medium 163. The liquid absorption element 164 is made of rigid porous material materials with liquid storage and heat-resisting features, such as silicone, porous ceramics, and the like. Accordingly, the liquid from the storage medium 163 can be uniformly dispersed in the interior and surface of the liquid absorption element 164 by capillary action. The liquid absorption element 164 defines an internal atomizing passage 165 in an axial direction communicated with the channel 161.

The heating element 166 is connected to the liquid absorption element 164. In the illustrated embodiment, the heating element 166 is a substantially spiral tubular heating wire received in the atomizing passage 165. The heating element 166 extends in a same direction as that of the atomizing passage 165. The conventional heating wire is laterally positioned in an air flow passage of the conventional electronic cigarette. Due to the small diameter of the air flow passage, only a small winding number of the heating wire can be arranged. However, in the illustrated embodiment, the heating element 166 extends in a same direction as that of the atomizing passage 165, such that the winding number of the heating wire can be greatly increased, thereby improving the heating area and the atomizing effect. The heating element 166 is made of flexible metals or alloys, preferably nichrome wire. Since the heating element 166 has certain flexibility, and the liquid absorption element 164 is made of rigid material, the heating element 166 can therefore be fixed directly in the atomizing passage 165 without the aim of a support element, thus simplifying the structure. Both ends of the heating element 166 are coupled to the power source 180 via two wires 182. When the heating element 166 is powered, the liquid absorption element 164 can be heated by the heating element 166, such that the liquid stored inside the liquid absorption element 164 will be uniformly heated and atomized into uniform vapor particles (i.e. smoke). The smoke enters the channel 161 through the atomizing passage 165, and finally inhaled by the user via the air outlet 142.

The power source 180 includes an electrode holder 184 and a battery (not shown). Both ends of the heating element 166 are coupled to the electrode holder 184 of the power source 180 via two wires 182. The battery is used for providing power for the heating element 166. It is to be understood that, the power source 180 may also include a sensor, an indicator, etc.

Compared with the prior art, the liquid absorption element 164 of the electronic cigarette has a greater area, it has a greater contact area with the heating element 166, which results in a better atomizing effect.

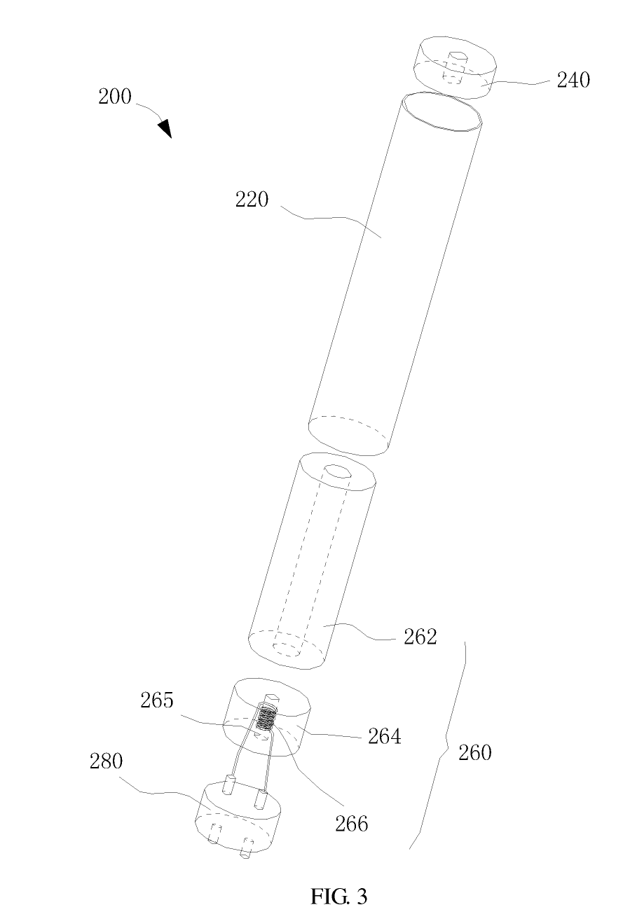

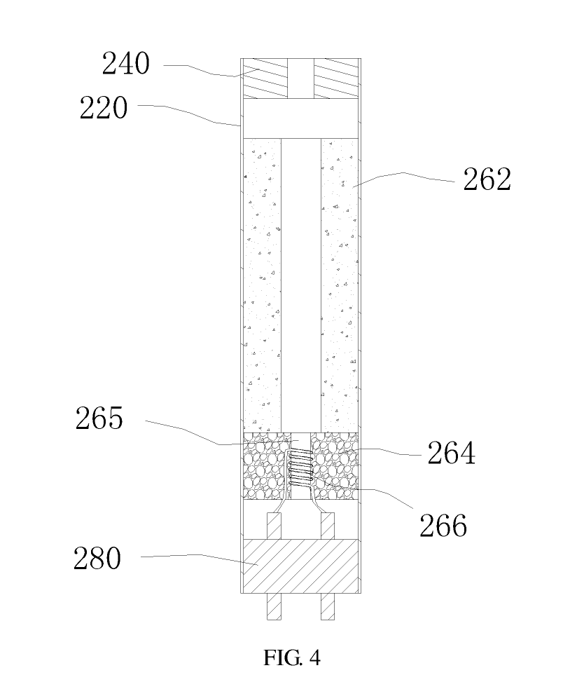

Referring to FIG. 3 and FIG. 4, a second embodiment of an electronic cigarette 200 is similar to the electronic cigarette 100 of the first embodiment. The electronic cigarette 200 includes a housing 220, a mouthpiece 240, an atomizing assembly 260, and a power source 280. The difference lies in that: the liquid absorption element 264 is shaped as tube matching with the housing 220. The liquid absorption element 264 is received in the housing 220 and located at an end of the liquid reservoir 262. The liquid from the liquid reservoir 262 can be uniformly dispersed in the interior and surface of the liquid absorption element 264 by capillary action. The liquid absorption element 264 defines an internal atomizing passage 265 in an axial direction communicated with the channel 261. The heating element 266 is a substantially spiral tubular heating wire received in the atomizing passage 265. Compared with the first embodiment, the liquid absorption element 264 has a larger diameter, thus it can absorb or restore more liquid.

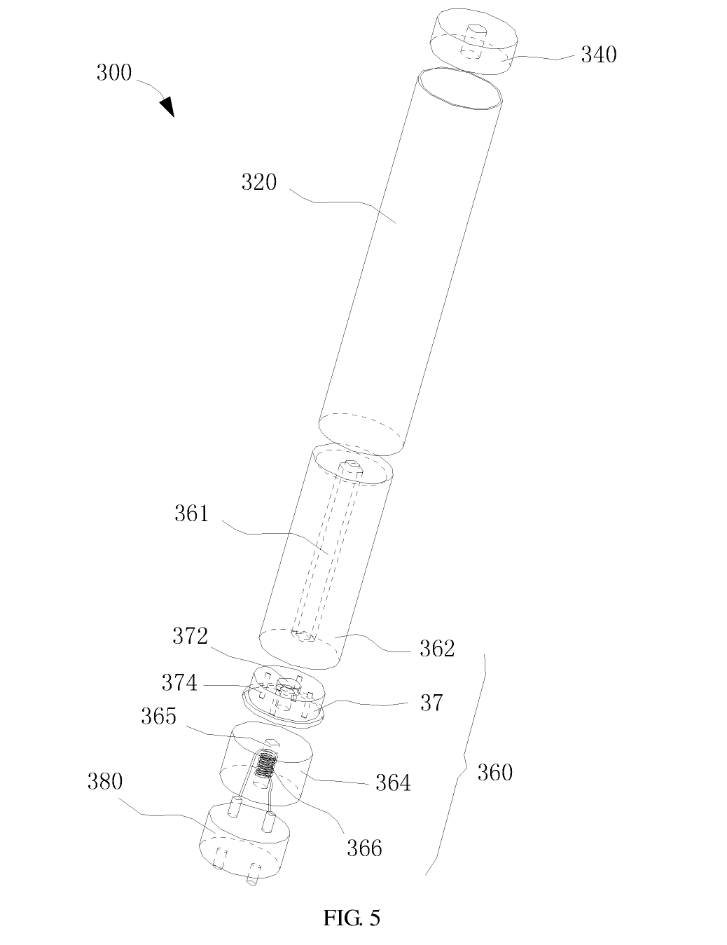

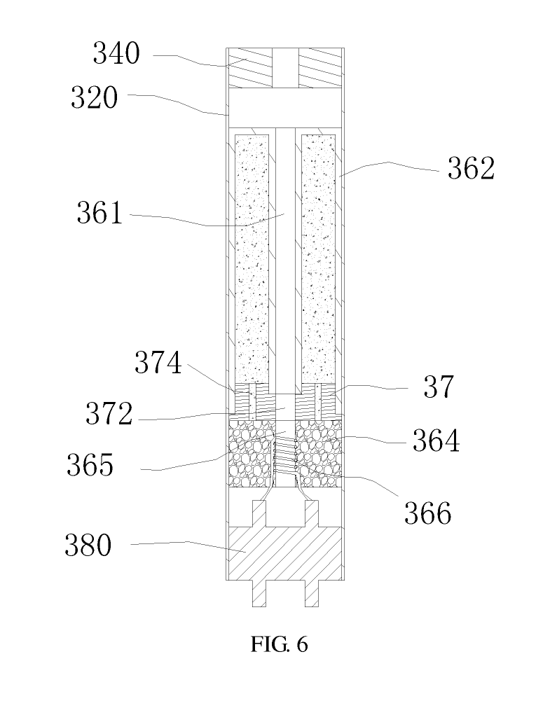

Referring to FIG. 5, and FIG. 6, a third embodiment of an electronic cigarette 300 is similar to the electronic cigarette 200 of the second embodiment. The electronic cigarette 300 includes a housing 320, a mouthpiece 340, an atomizing assembly 360, and a power source 380. The difference lies in that: the electronic cigarette 300 further includes a reservoir cover 37 positioned between the liquid reservoir 362 and the liquid absorption element 364. The reservoir cover 37 is shaped as a round cover and is located at an end of the liquid reservoir 362 to seal the liquid reservoir 362. The reservoir cover 37 defines an airflow channel 372 in a middle portion thereof communicated with the channel 361. The reservoir cover 37 further defines four liquid conduction channels 374 evenly distributed around the airflow channel 372. The liquid in the liquid reservoir 362 can flow into the liquid absorption element 364 via the four liquid conduction channels 374. The liquid absorption element 364 defines an internal atomizing passage 365 in an axial direction communicated with the airflow channel 372. The heating element 366 is received in the atomizing passage 365. Compared with the second embodiment, the liquid of the third embodiment can flow into the liquid absorption element 364 via the liquid conduction channels 374, such that the flow of liquid can be more accurately controlled. It should be noted that, the number of the liquid conduction channels 374 can be three, five or more.

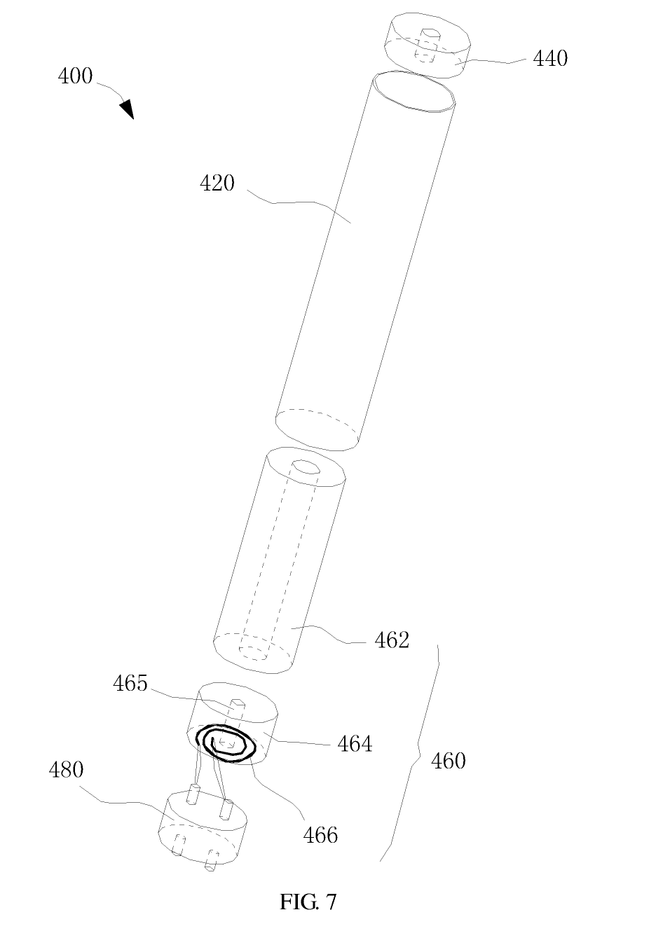

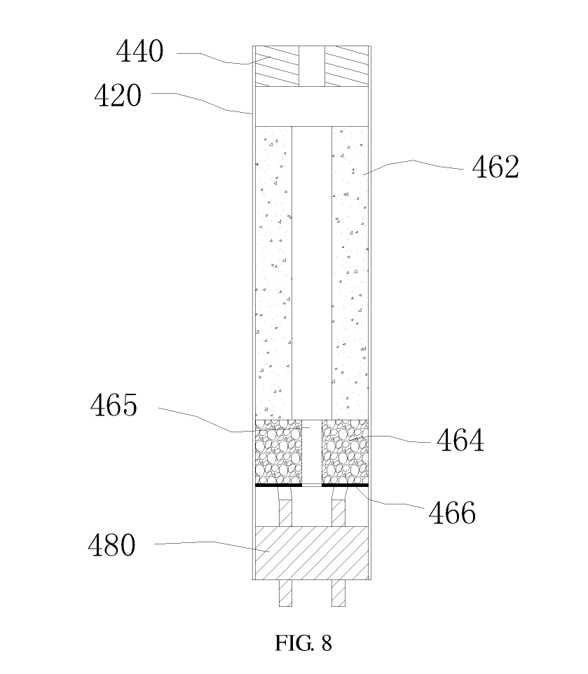

Referring to FIG. 7 and FIG. 8, a fourth embodiment of an electronic cigarette 400 is similar to the electronic cigarette 200 of the second embodiment. The electronic cigarette 400 includes a housing 420, a mouthpiece 440, an atomizing assembly 460, and a power source 480. The difference lies in that: the heating element 466 is located at an end of the liquid absorption element 464 away from the liquid reservoir 462. The heating element 466 is a planar spiral heating wire, and both ends of the heating wire are connected to the power source 480 via wires. Compared with the second embodiment, the heating element 466 of the fourth embodiment has a greater area and a better heating effect.

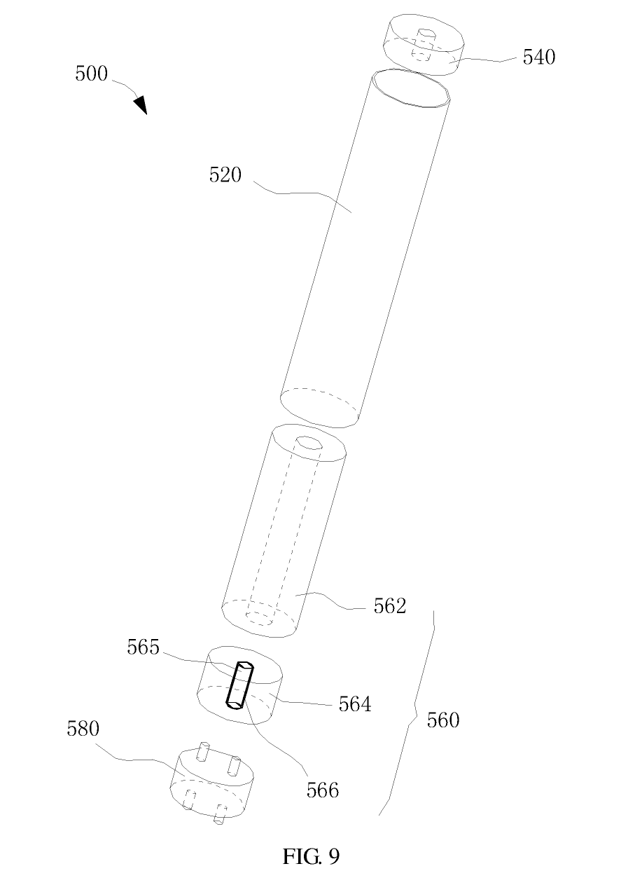

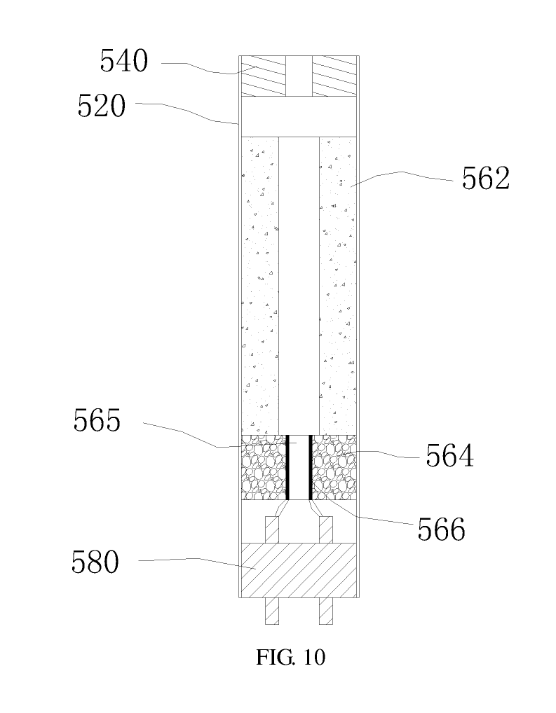

Referring to FIG. 9 and FIG. 10, a fifth embodiment of an electronic cigarette 500 is similar to the electronic cigarette 200 of the second embodiment. The electronic cigarette 500 includes a housing 520, a mouthpiece 540, an atomizing assembly 560, and a power source 580. The difference lies in that: the heating element 566 is a heating coating coated on an inner sidewall of the atomizing passage 565. The heating coating can be a metal heating film or non-metallic heating film. The heating coating can be coated on the inner sidewall of the atomizing passage 565 by printing and is coupled to the power source 380 via wires. Compared with the second embodiment, besides heat conduction through the air convection, the heating coating can conduct heat using far infrared radiation due to the planar heating, thus it can save power compared to other heating methods.

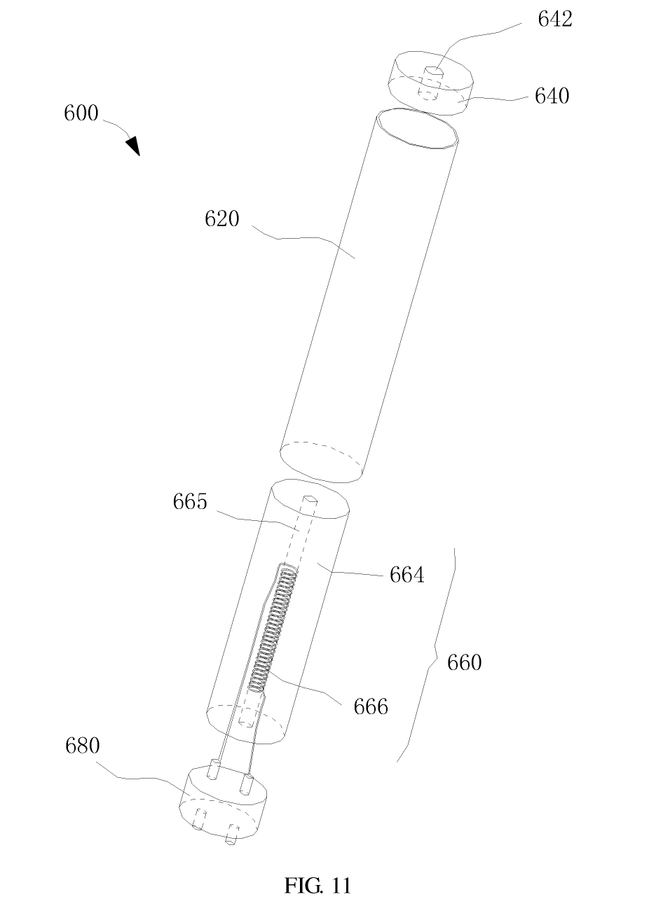

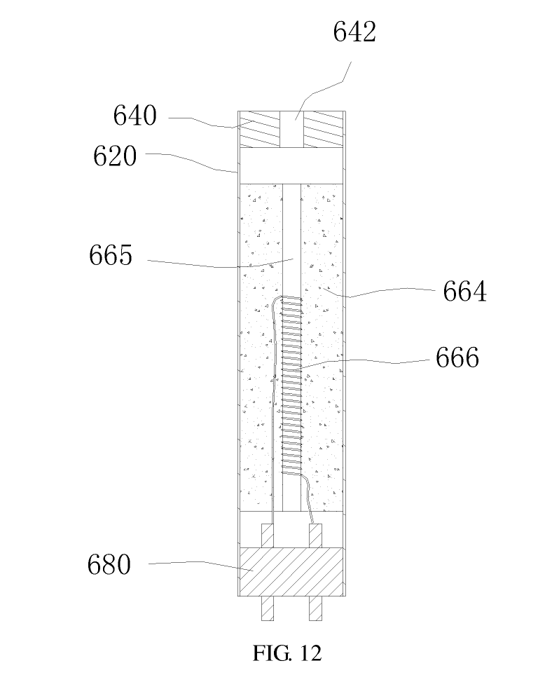

Referring to FIG. 11 and FIG. 12, a sixth embodiment of an electronic cigarette 600 is similar to the electronic cigarette 100 of the first embodiment. The electronic cigarette 600 includes a housing 620, a mouthpiece 640, an atomizing assembly 660, and a power source 680. The difference lies in that: the atomizing assembly 660 includes a liquid absorption element 664 and a heating element 666 but without the liquid reservoir. Since the liquid absorption element 664 itself has a feature of absorption, it can be used to restore liquid directly. Since the liquid reservoir is omitted, the atomizing passage 665 of the liquid absorption element 664 is communicated with the air outlet 642 directly. Compared with the first embodiment, the electronic cigarette 600 of the sixth embodiment has a simple structure.

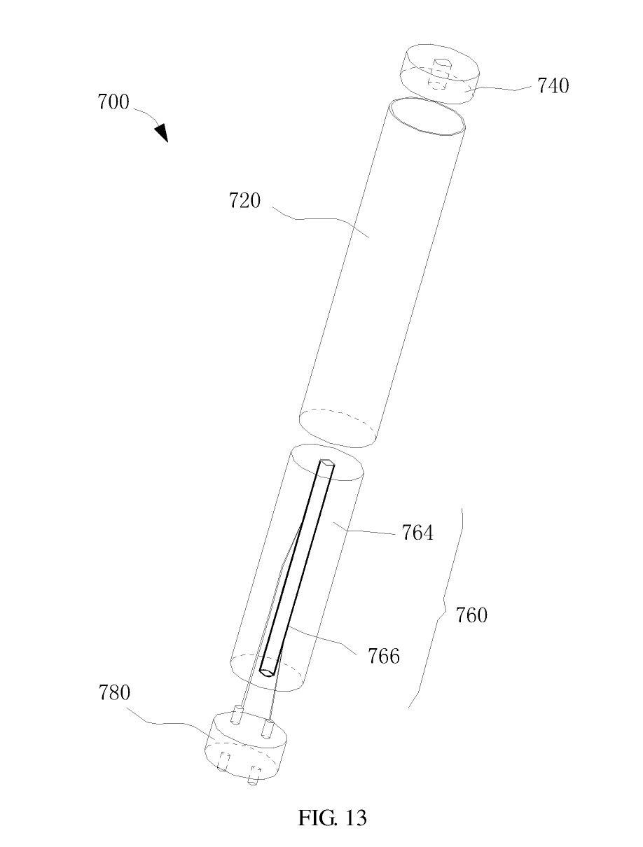

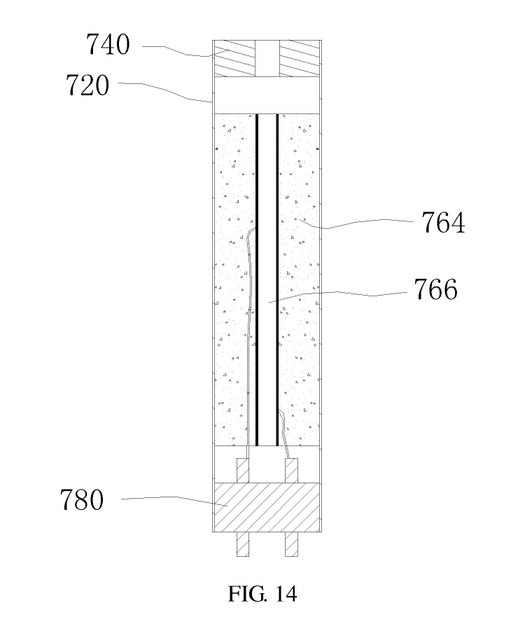

Referring to FIG. 13 and FIG. 14, a seventh embodiment of an electronic cigarette 700 is similar to the electronic cigarette 600 of the sixth embodiment. The electronic cigarette 700 includes a housing 720, a mouthpiece 740, an atomizing assembly 760, and a power source 780. The difference lies in that: the heating element 766 is a heating coating coated on an inner sidewall of the atomizing passage 765. The heating coating has the same structure and feature as that of the fifth embodiment, which has a better heating effect and can save power. It should be understood that, in alternative embodiment, the heating element 766 can be planar spiral heating wire located at an end of the liquid absorption element 764 away from the mouthpiece 740.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. An electronic cigarette, comprising:
a housing;
a mouthpiece located at an end of the housing, the mouthpiece defining an air outlet thereof;
an atomizing assembly received in the housing, the atomizing assembly comprising:
a liquid reservoir for storing liquid, the liquid reservoir defining a channel therethrough communicated with the air outlet;
a liquid absorption element connected to the liquid reservoir, the liquid absorption element being configured to absorb the liquid; and
a heating element connected to the liquid absorption element, the heating element being configured to atomize the liquid absorbed by the liquid absorption element into atomized gas, the atomized gas entering the channel; and
a power source received in the housing and connected to the atomizing assembly, the power source being configured to provide power for the heating element.

2. The electronic cigarette according to claim 1, wherein the liquid absorption element is made of porous ceramic.

3. The electronic cigarette according to claim 1, wherein the liquid absorption element is received in the channel, the liquid absorption element defines an atomizing passage therethrough communicated with the channel, the heating element is received in the atomizing passage.

4. The electronic cigarette according to claim 3, wherein the heating element is a spiral tubular heating wire, both ends of the heating wire are connected to the power source via wires.

5. The electronic cigarette according to claim 1, wherein the liquid reservoir is filled with a storage medium.

6. The electronic cigarette according to claim 1, wherein the liquid absorption element is located at an end of the liquid reservoir, the liquid absorption element defines an atomizing passage therethrough communicated with the channel, the heating element is received in the atomizing passage.

7. The electronic cigarette according to claim 1, further comprising a reservoir cover positioned between the liquid reservoir and the liquid absorption element, wherein the reservoir cover defines a liquid conduction channel and an airflow channel, the liquid enters the liquid absorption element via the liquid conduction channel, the airflow channel is communicated with the channel, the liquid absorption element defines an atomizing passage therethrough communicated with the channel, the heating element is received in the atomizing passage.

8. The electronic cigarette according to claim 1, wherein the liquid absorption element is located at an end of the liquid reservoir, the liquid absorption element defines an atomizing passage therethrough communicated with the channel, the heating element is located at an end of the liquid absorption element away from the liquid reservoir.

9. The electronic cigarette according to claim 8, wherein the heating element is a planar spiral heating wire, both ends of the heating wire are connected to the power source via wires.

10. The electronic cigarette according to claim 1, wherein the liquid absorption element is located at an end of the liquid reservoir, the liquid absorption element defines an atomizing passage therethrough communicated with the channel, the heating element is a heating coating coated on an inner sidewall of the atomizing passage.

11. An electronic cigarette, comprising:
a housing;
a mouthpiece located at an end of the housing, the mouthpiece defining an air outlet thereof;
an atomizing assembly received in the housing, the atomizing assembly comprising:
a liquid absorption element configured to absorb liquid, the liquid absorption element defining an atomizing passage therethrough communicated with the air outlet; and
a heating element connected to the liquid absorption element, the heating element being configured to atomize the liquid absorbed by the liquid absorption element into atomized gas, the atomized gas entering the channel; and
a power source received in the housing and connected to the atomizing assembly, the power source being configured to provide power for the heating element.

12. The electronic cigarette according to claim 11, wherein the liquid absorption element is made of porous ceramic.

13. The electronic cigarette according to claim 11, wherein the heating element is spiral tubular heating wire, both ends of the heating wire are connected to the power source via wires.

14. The electronic cigarette according to claim 11, wherein the heating element is a heating coating coated on an inner sidewall of the atomizing passage.

15. The electronic cigarette according to claim 11, wherein the heating element is a planar spiral heating wire located at an end of the liquid absorption element away from the mouthpiece.
